(19) United States
(12) Patent Application Publication
(10) Pub. No.: US 2020/0134210 A1
(43) Pub. Date: Apr. 30, 2020

(54) DEVICE AND METHOD FOR PROVIDING SECURE TRANSMISSION OF DATA BETWEEN A TRANSMITTER AND A RECEIVER

(71) Applicants: Pierino VIDONI, Bienne (CH); Marta Dorothea ALTENKAMP, Aesch, Basel-Landschaft (CH)

(72) Inventors: Pierino VIDONI, Bienne (CH); Marta Dorothea ALTENKAMP, Aesch, Basel-Landschaft (CH)

(21) Appl. No.: 16/335,805

(22) PCT Filed: Sep. 21, 2017
(86) PCT No.: PCT/EP2017/073915

§ 371 Date: Nov. 4, 2019

(30) Foreign Application Priority Data
Sep. 23, 2016 (CH) 01241/16

(51) Int. Cl. G06F 21/60

(52) U.S. Cl. CPC G06F 21/606

(57) ABSTRACT

A device for providing secure transmission of data between a transmitter and a receiver includes an interface circuit that includes a first input circuit arranged to receive data to be transmitted, the first input circuit comprising programmable logic for transforming said data to be transmitted, the programmable logic being built in the first input circuit by a first controller; a first output circuit arranged to receive the data transformed by the first input circuit, the first output circuit comprising programmable logic for retransforming said transformed data, the programmable logic being built by a second controller, and a first comparator arranged to compare said data retransformed by the first output circuit and the data to be transmitted, the programmable logic of the first input circuit being inverse and complementary to the programmable logic of the first output circuit. Also disclosed is a method implemented by the device described above.

### TECHNICAL AREA

The present invention relates to a device for securing data transmission between a transmitter and a receiver. It also relates to a method for securing the transmission of data between a transmitter and a receiver.

More specifically, this invention relates to the protection of the interconnection between a transmitter and a receiver, this protection being intended to prevent any reading or modification by an unauthorized person, data exchanged between a transmitter and a receiver.

### PRIOR ART

In conventional devices for transmitting or exchanging data between a transmitter and a receiver, the data can be encrypted with more or less powerful algorithms to guarantee the secrecy of the information when necessary. The data is encrypted using an algorithm, for example using a disposable key or a public/private key pair depending on the system and the desired degree of protection of the message.

There is no hardware or hardware system preventing access to a transmission device or a connected object.

In standard transmission devices, the data is simply transmitted from the receiver to an output interface logic or input interface logic to the transmitter without a control system.

In these devices of the prior art, the identification and authentication of the receiver is made only by a protocol defined in a software way, which can be more or less easy to attack. From the moment when the address of the receiver is known, one can continually send him messages, sometimes going to saturate it.

In the devices of the prior art, there is no physical protection or hardware dedicated to the interconnection itself. All protection, including identification and authentication, is provided by the software.

### STATEMENT OF THE INVENTION

The problems with which the devices of the prior art are confronted include the following: once we have the address of the receiver, for example the IP address in the case of an Internet connection, we can send messages and fill or saturate the data receiver with spam or other messages. If we add a hardware layer dedicated only to the interconnection, this can not happen.

For example, if a hardware layer is added in a modem that allows or prevents the connection, a denial of service attack can not occur. Indeed, the modem itself cuts the line if this hardware layer is added.

This hardware layer is particularly interesting if one wants to address a device that must have a very high degree of protection, especially in the case where it is desired to completely isolate a connected application so as not to be able to attack by software attack.

The best way to isolate a device if you want to be sure that it will not be attacked from the outside would be to cut the connection when it is not used. At this time, no type of attack can occur on the system thus disconnected.

The present invention proposes to provide a device in which effective protection is provided, in particular so as to prevent this device from being attacked and that it delivers confidential information.

The object of the invention is achieved by a device for securing data transmission between a transmitter and a receiver, comprising an interface circuit connected between the transmitter and the receiver, characterized in that the interface circuit comprises:
a first input circuit arranged to receive data to be transmitted, this first input circuit comprising programmable logic for transforming said data to be transmitted, this programmable logic being constructed in the first input circuit by a first controller;
a first output circuit arranged to receive the data transformed by the first input circuit, this first output circuit comprising programmable logic for retransforming said transformed data, this programmable logic being constructed in the first output circuit by a second controller; and
a first comparator arranged to compare said data retransformed by the first output circuit and the data to be transmitted, the programmable logic of the first input circuit being inverse and complementary to the programmable logic of the first output circuit.

The objects of the invention are also achieved by a method of securing data transmission between a transmitter and a receiver by means of an interface circuit connected between the transmitter and the receiver, this interface circuit comprising:
a first input circuit arranged to receive data to be transmitted, this first input circuit comprising programmable logic for transforming said data to be transmitted, this programmable logic being constructed in the first input circuit by means of a first controller;
a first output circuit arranged to receive the data transformed by the first input circuit, this first output circuit comprising programmable logic for retransforming said transformed data, this programmable logic being constructed in the first output circuit by means of a second controller; and
   a first comparator arranged to compare said data retransformed by the first output circuit with the data to be transmitted, this method being characterized in that it comprises the following steps:
in said first input circuit, construction by said first controller of programmable logic by means of programming information;
construction by said second controller, a programmable logic in said first output circuit, said programmable logic in said first input circuit and in said first output circuit being inverse and complementary;
transmitting data from the transmitter to the first input circuit, this first input circuit transforming the data in a manner dependent on the programmable logic of the first input circuit;
transmitting said transformed data to the first output circuit and retransforming the data in a manner dependent on the programmable logic of the first output circuit;
Comparison of the transmitter data with the retransformed data and activation of a countermeasure if the comparison of the transmitter data with the retransformed data indicates a difference.

More generally, the purpose of the present invention is to add a hardware layer that can be applied to any information transfer system. This layer deals only with the protection of the access itself.

It is therefore a hardware or hardware layer, independent of the software layers, which can be applied in addition to any data transmission system in which there is identification of the transmitter and the receiver. This hardware layer is independent of software protection. It can be applied in a system where the data is encrypted or not.

According to the connected objects, the protection provided by the device of the invention is very important, especially in certain areas where the data can be strategic.

This device is especially useful if it is integrated with a communication modem, to isolate all or part of a system. The invention is of interest wherever there is access to remote control systems, bidirectional or unidirectional important. As this device is an independent element, it can be added in any kind of existing objects, depending on their importance.

This is particularly interesting in the context of the Internet of Things (IOT), part of the connected objects requiring indeed a high level of protection. The invention is of interest in the case of communications with commands, cars, remote controls of parameters or interfaces allowing remote actions on buildings, and more generally in cases where there are effects that could be harmful if we can connect and act on these objects.

The level of protection achieved by the device of the invention being sufficiently high, even using only this connection protection, it is not necessary, in a large number of cases, to encrypt the data, in particular in applications concerning 10T. Such an encryption is however possible without changing the operation of the device of the invention. As the device of the invention is independent, added to the applications, the normal data traffic, encrypted or not, can go to very high speed, without delay once the connection is allowed.

The present invention makes it possible to create a system in programmable logic whose circuit is empty at the beginning of the transmission, this logic being loaded at the beginning of the transmission. This logic is maintained in an editable temporary RAM type memory.

This protection circuit is interposed between the transmitter/receiver circuits and the input/output interface circuits. This circuit is controlled by two microcontrollers, namely an input microcontroller and an output microcontroller.

### SUMMARY DESCRIPTION OF THE DRAWINGS

The present invention and its advantages will be better understood with reference to the appended figures and to the detailed description of particular embodiments, in which:

FIG. 1 is a diagram of a device according to the invention, according to a unidirectional embodiment;

FIG. 2 represents a device according to the invention, according to a bidirectional embodiment;

FIGS. 3a to 3d illustrate types of cells that can be used in a device according to the invention.

FIG. 4 represents a circuit used in a device according to the invention for transforming data;

FIG. 5 shows an example of a message for the construction of the programmable logic.

### MANNER OF REALIZING THE INVENTION

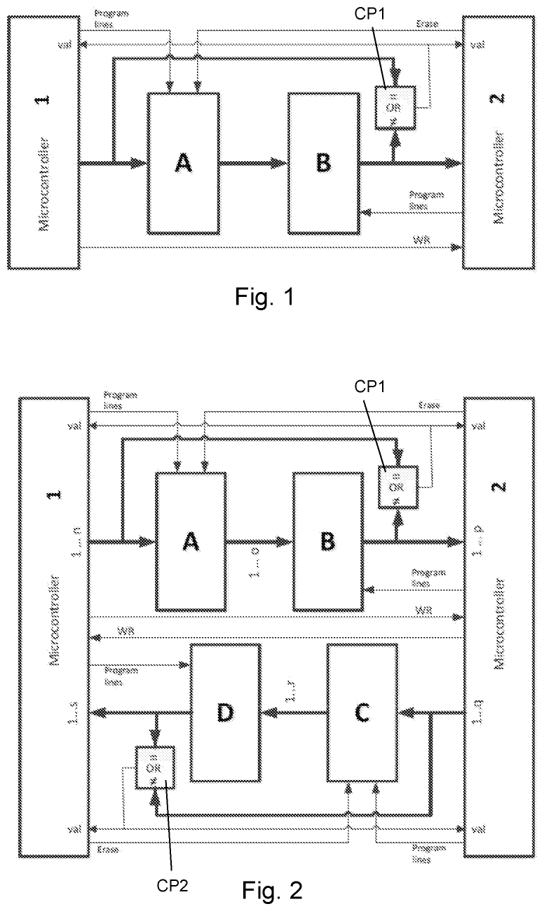

FIG. 1 illustrates an embodiment of a device according to the invention, in a unidirectional embodiment. With reference to this figure, the device according to the invention comprises a first input circuit A and a first output circuit B. These two circuits comprise a programmable logic, the programmable logic of one of the circuits being able to be recorded in a unchangeable. When both circuits work properly, the programmable logic of each is complementary. These circuits may include reversible cells, which can easily be implemented in programmable logic. This circuit can use cells such as NOT cells, Feynmann cells, Toffoly cells or Fredkin cells in particular. Cells of this type are illustrated in FIG.

The device of the invention further comprises two microcontrollers, one of the microcontrollers 1 being connected to the first interface circuit A on the one hand and to a transmitter (not shown) on the other hand. The other microcontroller 2 is connected to the first output circuit B on the one hand and to a receiver (not shown) on the other hand. When the device is switched on, the second microcontroller 2 will download a content that it has in fixed memory, flash, EEPROM and build the logic of the first output circuit B. (see FIG. 1).

The input/output interfaces are then ready to receive data transfer commands or messages containing data or information. In the case of FIG. 1, only the output lines are activatable to give commands.

In the current state, the logic circuit of the first input circuit A is completely empty and can be set to high impedance since no data enabling the creation of a circuit have been downloaded from the first microcontroller 1 which controls this circuit. first input circuit A.

The first microcontroller 1 is connected to the transmitter/receiver interfaces which can use a wide variety of protocols depending on the tasks to be performed. These protocols can be Wifi, Bluetooth, Zigbee, Ethernet, IOT protocols or others . . . .

According to this invention, it is not possible to transmit data to the interfaces before having transmitted a block of data necessary for the creation of the logic of the first input circuit A by means of a secure protocol. Such a data block is sent in a message containing a corresponding instruction or command.

If the first microcontroller 1 receives an order in the correct format, it will implement a programmable logic in the first input circuit A. This programmable logic must be complementary to the logic implemented in the first output circuit B which has been implemented during the first circuit. power on the device.

Only those who know the logic implemented in the first output circuit B can implement the complementary logic in the first input circuit A and thus communicate with the first output circuit B. This programmable logic corresponds to a key that can have several thousand of bits that it is necessary to send for the creation of the logic circuit in the first input circuit A.

To transmit data to interfaces from a receiver, there are always three phases:
Phase 1: Receiving construction data from programmable logic
Phase 2: Data packet transmission if the construct is valid
Phase 3: Deleting the logic at the end of transmission

According to one variant, it is possible to add a command for the second microcontroller 2 telling it that after a certain period of transmission inactivity, the phase 3 of erasure of the logic is automatically triggered.

During the first phase, namely the phase of receiving data allowing the construction of the programmable logic, several variants are possible if the data received by the microcontroller are not in conformity. According to a first variant, the first microcontroller 1 does not respond and the logic is not built in the first input circuit A. According to a second variant, the first microcontroller 1 responds according to a determined protocol. This protocol could for example be:
blocking after 3 trials, unlocking not a system similar to what is used in mobile telephony, PUK code type.
blocking after a defined number of tests, for example 3, then admission of new tests according to a time window, incremental or not, for example after 1 second, 10 s, 1 minute, 10 min, etc.

It is clear that many other protocols are possible.

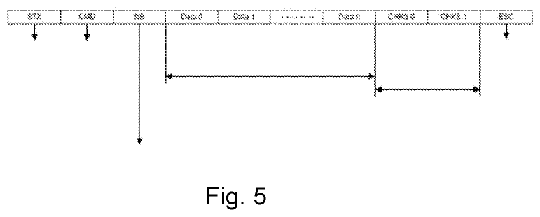

FIG. 5 illustrates an order example sent to the first input circuit A for constructing the logic. This example is described in detail below.

Sending a STX start character, then a CMD command, then a number of NB bytes indicating the size or length of the message. The order continues with a certain number of data Data 0, Data 1, . . . corresponding to the “useful part” of the message, ie for example the part making it possible to construct the logic to be implemented in the input circuit. The order continues with one or more control bytes CHKS0, CHKS1, and ends with an end character ESC. This is just an example of a sending protocol for commands to the first microcontroller 1. The protocol is structured according to the applications.

If the message received to build the logic is compliant, the logic circuit corresponding to this data is loaded and functional.

The number of orders available is variable. It is possible to add some as needed. Each CMD order corresponds to a number of bytes that may be different from one order to another. Indeed, some orders are very short while others, such as the construction of logic, are much longer.

In phase 2, namely the data packet transmission phase, each packet from the transmitter is transferred to the first input circuit A. The packets are then transformed according to the programmable logic implemented in this first circuit. input A. The transformed data is then transmitted to the first output circuit B in which the data is retransformed according to the programmable logic implemented in this first output circuit B.

Each packet of bits 1 . . . n, input in the first input circuit A is compared with the result of the retransformation of the corresponding packet by the first output circuit B. As the first output circuit B performs the operation inverse to that performed in the first input circuit A, the result of the comparison indicates that the values are equal if the logic of the first output circuit is inverse and complementary to the logic of the first input circuit A or in other words, if the circuits are correctly initialized.

The interface circuit according to the invention further comprises a write line (WR). It is this line which informs the second microcontroller 2, driving the first output circuit B, that the first input circuit A has received data from the first controller 1 and that the second microcontroller 2 can read the result of the comparator indicating whether the transmission is valid or not.

According to a variant, if the transmission is not valid, the second microcontroller 2 can reset (erase) the logic in the first input and/or output circuits.

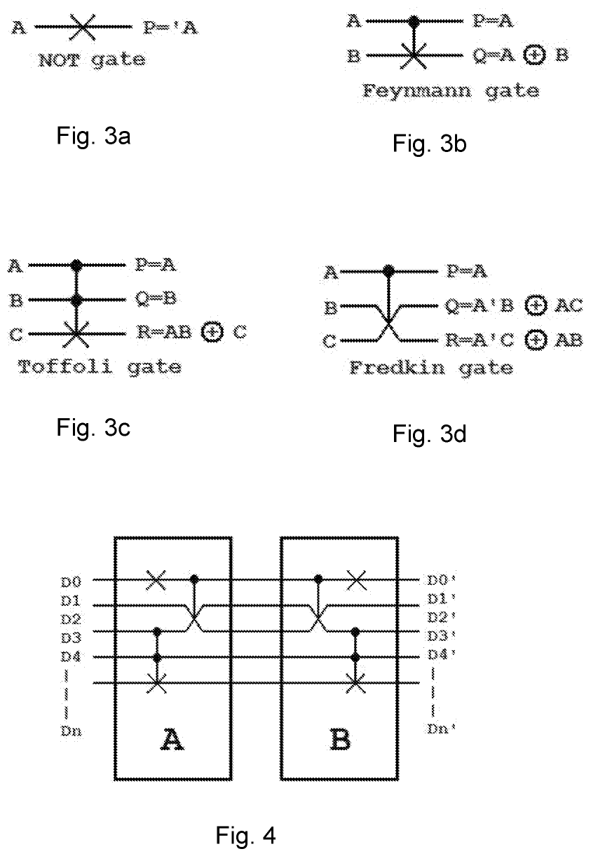

Many variants can be used for the programmable logic. Indeed, any symmetrical reversible logic system can be used to create a logic circuit in the circuits A and B. The cells as illustrated by FIG. 3 are easy to implement in programmable logic and make it possible to create networks with lines permuted, inverted or not, depending on the value of the data. If instead of cells, Universal Asynchronous Receiver Transmitter (UART) transceivers are implemented with a number of variable bits, for example, and on both sides, the same circuit is copied, it works.

In the example illustrated, the logic circuits are represented as using cells such as a NOT gate, a Feynmann cell, Toffoli cell and Fredkin cell (see FIGS. 3a to 3d for the symbols used).

The comparator CP1 is provided to compare the data entered in the first input circuit A and the data retransformed by the output circuit B, this comparison inducing a very low delay time. The comparison only gives the value “fair” or “false”. In the case where the comparison indicates that the compared data is different, the communication is stopped and the logic contained in the input and/or output circuits is cleared. Other countermeasures can of course be implemented. It is possible to count the number of unsuccessful attempts for statistics if you want, to know the unsuccessful access attempts.

FIGS. 3a to 3d illustrate four examples of reversible cells that can be used in the present invention. These cells are a NOT cell, a Feynmann cell, a Toffoli cell and a Fredkin cell.

The NOT cell (FIG. 3a) is the simplest example of a reversible cell, it simply consists of a logic inverter.

The CN cell, CONTROLLED NOT (FIG. 3b) or Feynmann cell, consists of a NOT cell whose logic inverter is controlled, the simplest way to implement it is with a simple XOR circuit.

The CCN cell, CONTROLLED CONTROLLED NOT (FIG. 3c) or Toffoli cell, consists of a NOT cell whose logical inverter is controlled by the result of the AND of two commands. It is necessary that the lines C1 and C2 are with 1 so that the circuit activates NOT, otherwise, the exit is direct. The simplest way to implement it is with a simple XOR circuit whose branches are connected to an AND circuit.

The Fredkin cell (3d), allows according to the state of the command line C, to reverse or not the lines A and B. This cell uses a little more space in programmable logic than the previous simple circuits. It is also called SWAP or CSWAP because it allows to swap lines.

FIG. 4 illustrates an exemplary implementation of cells in the input A and output B circuits. FIG. 4 also illustrates an example of partial filling on a few bits.

The data received at the input of the first input circuit A is inverted, crossing bits or inverting bit results according to the values. It is as if the values were encrypted by the input circuit A without waiting, with only the transition time through this circuit followed by the transition delay in the output circuit B.

The comparison of the initial data with the retransformed data, obtained after the passage in the first input and output circuits, validates the transmission during the pulse on the line WR (write).

If the signal is not validated, it completely clears the contents of the input circuit A, which cuts off any possibility of erroneous transmission and the transmitter must reset the circuit.

Realization of a Bi-Directional System

FIG. 2 illustrates an embodiment of a bidirectional system

In the explanation of the operation of an access construction/destruction device given above, the system was unidirectional. In practice, rather, bidirectional input/output systems are used. To do this, a bidirectional system as illustrated in FIG. 2 comprises a second input circuit C and a second output circuit D, the second input circuit C being controlled by the second microcontroller 2 and the second input circuit. D output being controlled by the first microcontroller 1. Thus, the device according to the invention comprises a “set of communication” for each direction.

The first microcontroller 1 in this case has two circuits to be initialized and programmed according to the received data. It must indeed manage the programmable logic of the first input circuit A and the second output circuit D. The second microcontroller 2 loads the first output circuit B and the second input circuit C with its internal data when setting under pressure.

Each communication assembly formed of an input circuit and the output circuit corresponding to a comparator CP1, CP2 and a write line as well as means for erasing the programmable logic.

The system according to the present invention has the following advantages:
Very high reliability, unable to contact the target and transmit or read data without the bit packet necessary for initialization is accurate. If only one bit is different, the input circuit does not work.
No delay of calculations in the transmission (very high speeds possible), just a transition time in the logic. This is a great advantage for systems, for example for the IOT which would have a very high speed of information to pass without encrypting them.
low consumption
Audit system (feedback to a center) possible indicating for example the number of successful accesses, the number of refused access, etc . . . .

It should be noted that this system can be used independently of a cryptographic system. As such, it is possible to add between the transmitter and the first microcontroller 1, as well as between the second microcontroller 2 and the receiver, a cryptographic module in charge of encrypting/decrypting data.

According to different variants, it is possible to introduce a counter responsible for counting certain events, for example the number of successful accesses, the number of failed access attempts, etc. The second microcontroller 2 can always initialize the same programmable logic or on the contrary, use a different logic, according to a predetermined rule. It is also possible to provide a line of communication between the two microcontrollers, which allows the system to be reconfigured and the configuration to be exchanged between the two microcontrollers.

1. A device for providing secure transmission of data between a transmitter and a receiver, comprising an interface circuit connected between the transmitter and the receiver, wherein the interface circuit comprises:
a first input circuit arranged to receive data to be transmitted, the first input circuit comprising first programmable logic for transforming said data to be transmitted, the first programmable logic being constructed in the first input circuit by a first controller;
a first output circuit arranged to receive the data transformed by the first input circuit, the first output circuit comprising second programmable logic for retransforming said transformed data, the second programmable logic being built in the first output circuit by a second controller; and
a first comparator arranged to compare said data retransformed by the first output circuit and the data to be transmitted, the first programmable logic of the first input circuit being inverse and complementary to the second programmable logic of the first circuit output.

2. The device according to claim 1, wherein the first controller is configured to receive programming information for the first controller to build the programmable logic of the first input circuit.

3. The device according to claim 2, wherein the first controller is configured to receive the programming information by a secure route.

4. The device according to claim 1, wherein said interface circuit further comprises a second input circuit and a second output circuit,
said second input circuit being arranged to receive data to be transmitted, said second input circuit comprising third programmable logic for transforming said data to be transmitted, the third programmable logic being constructed in the second input circuit by means of said second controller;
said second output circuit being arranged to receive data transformed by the second input circuit, said second output circuit comprising fourth programmable logic for retransforming said transformed data, said fourth programmable logic being constructed in the second output circuit by means of said first controller; and
a second comparator arranged to compare said data retransformed by the second output circuit with the data to be transmitted.

5. The device according to claim 4, wherein the first controller is further configured to ensure that the logic of the first and second input circuits is inverse and complementary to the circuit logic corresponding to the first and second output circuits so that the data to be transmitted is equal to the retransformed data.

6. The device according to claim 4, further comprising means for inactivating the programmable logic of at least one of the first or second input circuits or the first and/or second output circuits.

7. The device according to claim 4, further comprising a write line arranged to allow one of said first or second controllers to indicate to the other controller that a data has been transmitted.

8. A method for providing secure transmission of data between a transmitter and a receiver by means of an interface circuit connected between the transmitter and the receiver, said interface circuit comprising:
a first input circuit arranged to receive data to be transmitted, the first input circuit comprising first programmable logic for transforming said data to be transmitted, the first programmable logic being constructed in the first input circuit by means of a first controller;
a first output circuit arranged to receive the data transformed by the first input circuit, the first output circuit comprising second programmable logic for retransforming said transformed data, the second programmable logic for retransforming said transferred data being built in the first output circuit by means of a second controller; and
a first comparator arranged to compare said data retransformed by the first output circuit with the data to be transmitted the method comprising the following steps:
in said first input circuit, constructing by said first controller the first programmable logic by means of programming information;
constructing by said second controller the second programmable logic in said first output circuit, said first programmable logic in said first input circuit and said second programmable logic in said first output circuit being inverse and complementary;
transmitting data from the transmitter to the first input circuit;
said first input circuit transforming the data in a manner dependent on the first programmable logic of the first input circuit;
transmitting said transformed data to the first output circuit and retransforming the data in a manner dependent on the second programmable logic of the first output circuit;
comparing the transmitter data with the retransformed data and activating a countermeasure if the comparison of the transmitter data with the retransformed data indicates a difference.

9. The method of claim 8, wherein said countermeasure comprises a step of stopping the data transmission.

10. The method according to claim 8, wherein said countermeasure comprises a step of modifying at least one of the first programmable logic of the first input circuit and the second programmable logic of the first output circuit.

11. The method according to claim 8, wherein the first controller receiving data from the transmitter sends a signal to the second controller connected to the receiver by means of a write line when a data has been transmitted to the first input circuit.

12. The method according to claim 8, wherein data is transmitted by an emitter connected to the first input circuit and data is also transmitted by a transmitter connected to a second input circuit.

13. The method of claim 8, wherein at least one of the programmable logic of the first input circuit and first output circuit are altered at the end of said data transmission.

14. The method of claim 13, wherein the alteration of the programmable logic comprises a step of erasing this logic.
